(19) United States
(12) Patent Application Publication
(10) Pub. No.: US 2007/0101778 A1
(43) Pub. Date: May 10, 2007

(54) Quick-release/secure lock converter and lock for a vending or gaming machine or the like

(75) Inventors: Trevor Perks, Sandford (GB); Dale N. Padjen, Pleasant Prairie, WI (US)

Correspondence Address: Basil E. Demeur, 7369 W. North Ave., River Forest, IL, 60305, US

(73) Assignee: CAMLOCK SYSTEMS LIMITED, EAST BOURNE (GB)

(21) Appl. No.: 11/407,834

(22) Filed: Apr. 21, 2006

(30) Foreign Application Priority Data
Nov. 10, 2005 (GB) 0522893.7

(51) Int. Cl. E05B 13/10

(52) U.S. Cl. 70/208

(57) ABSTRACT

A quick-release/secure lock for a vending machine or the like includes a shaft component, which may be a converter component, is secured on a threaded shaft of the machine, the shaft component is arranged with the remainder of the lock, to permit less than a single turn of the lock on the shaft component tightly to secure or release a machine cover or lid. The shaft component obviates the previous requirement to screw the lock through several turns on the machine shaft to tighten, to close or remove the cover or lid.

### BACKGROUND OF THE INVENTION

This invention relates to a quick-release/secure lock for a vending or gaming machine or the like requiring a tightly-locked lid and to a converter for an existing machine.

Locks are known to secure lid covers in place on vending and gaming machines or the like such as bulk vending machines offering, for example, bubble gum, prizes, etc.

Normally, the lid cover is screwed tightly into place on a threaded lock receiving shaft with a lock. Similarly, the lid cover is opened and removed by unscrewing the lock from the shaft and these actions are both time consuming for the operator and also have repetitive strain injury issues.

Accordingly, it is an object of the present invention to provide a quick-release/secure lock that could replace the aforesaid method and also to provide simultaneously a quick-release/secure converter, forming part of the quick-release/secure lock, which can be used to adapt existing machines.

### SUMMARY OF THE INVENTION

According to one aspect of the present invention, there is provided a quick-release/secure converter to convert a lock for a vending or gaming machine or the like, the machine being of a type which carries a threaded, lock-receiving shaft, onto a threaded end of which the lock is normally screwed, in known manner, in order to secure a closure lid in place over an opening in the machine; the quick-release/secure lock converter comprising a two-ended, internally-threaded shaft component for threadably engaging, at one end of the component, with the thread on the shaft and there being means to hold the component fast on the shaft once screwed onto it, and the shaft component having, at its other end, means to receive and capture a main body of the lock, so arranged to permit less than a single turn of the lock on the converter to capture or release the main body of the lock, the converter having been previously installed on the machine lock-receiving shaft in use of the lock and converter.

Preferably, the means to receive and capture the lock includes a slot open to said other end of the shaft component and having a first part running towards said one end of the shaft component and the slot at a portion of the converter remote from said other end having a second part turning at an angle to the general run of the first part and terminating at a blind end in the converter, said slot serving to receive a cross-pin of a barrel of the lock and thereby enabling the lock to be captured on the converter to tighten the lid securely once the cross-pin has entered said second part of said slot, whilst permitting less than a single turn of the lock on the converter.

Preferably the angle is such that the second part of the slot is helical.

According to another aspect of the present invention, there is provided a quick-release/secure lock for a vending or gaming machine or the like, the machine being of a type which carries a threaded, lock-receiving shaft, onto a threaded end of which the lock is normally screwed, in known manner, in order to secure a closure lid in place over an opening in the machine; the quick-release lock comprising a main body including a barrel within a housing, and there being a two-ended, internally-threaded shaft component for threadably engaging, at one end of the component, with the thread on the shaft and there being means to hold the component fast on the shaft once screwed onto it and the shaft component having, at its other end, means to receive and capture the main body of the lock, so arranged to permit less than a single turn of the main body of the lock on the shaft component to capture or release the main body of the lock, the shaft component having been previously installed on the machine lock-receiving shaft.

Preferably, the barrel has an open end within which a cross-pin is located and the means on the shaft component to receive and capture the main body of the lock includes a slot open to said other end of the shaft component and having a first part running towards said one end of the shaft component and the slot at a portion of the shaft component remote from said other end having a second part turning at an angle to the general run of the first part and terminating at a blind end in the shaft component, the slot serving to receive and capture the cross-pin of the barrel of the lock and thereby enabling the main body of the lock to be captured on the shaft component once the cross-pin has entered said second part of the slot, whilst permitting less than a single turn of the barrel of the lock on the shaft component.

As before, preferably the angle is such that the second part of the slot is helical.

The slot in the shaft component can be arranged to allow no more than one quarter of a turn of the lock and/or lock barrel to secure the machine cover tightly in place or to release it.

The housing may, of course, be provided with a keyhole to receive a key.

### BRIEF DESCRIPTION OF THE DRAWINGS

For a better understanding of the invention and to show how the same may be carried into effect, reference will now be made, by way of example, to the accompanying drawings, in which:

FIGS. 1A and 1B are perspective views of a shaft component of the lock, which component can also be used as a converter for locks on existing machines,

FIGS. 2A, 2B and 2C are respectively a plan view, side view and underneath view of the shaft component,

FIG. 3 is an exploded view of the present lock with the shaft component and showing also part of a lock-receiving shaft and of a closure cover of the machine,

FIG. 4 is an exploded side view of the components shown in FIG. 3,

FIG. 5 is another exploded view from the opposite perspective to that shown in FIG. 3, and

FIG. 6 is a perspective view of the assembled lock mounted in position holding the closure cover of the machine fast on the machine shaft.

### DESCRIPTION OF THE PREFERRED EMBODIMENT

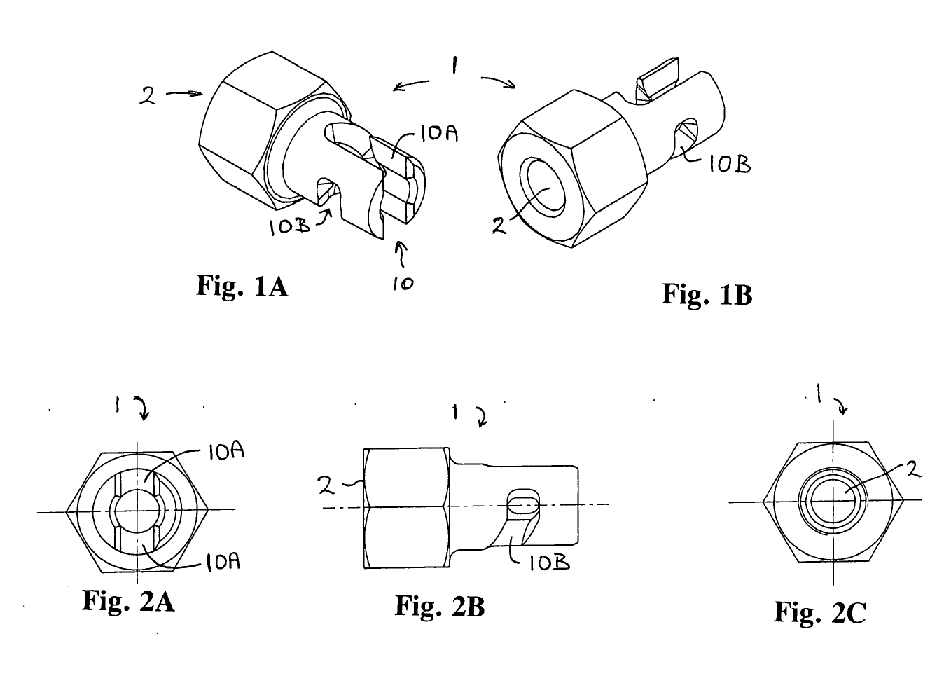

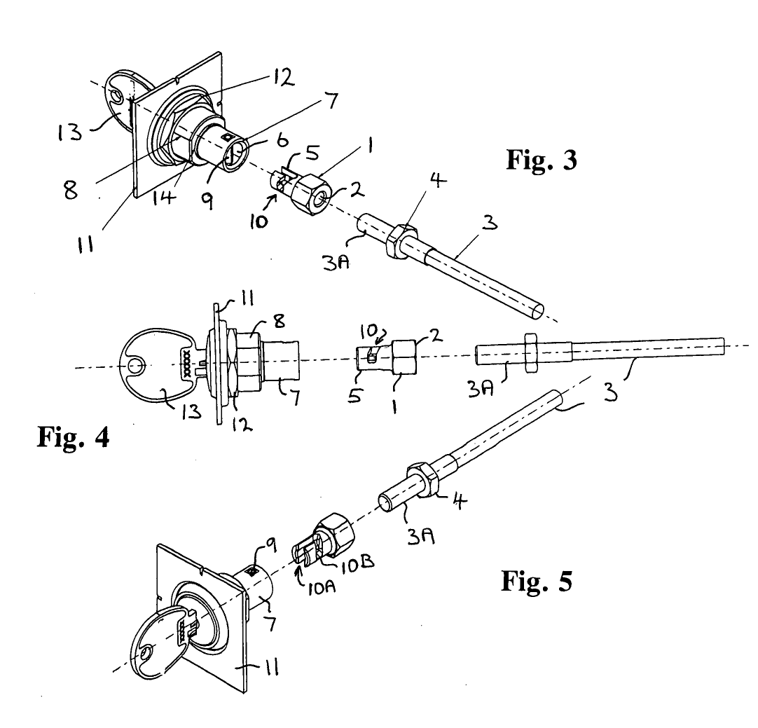

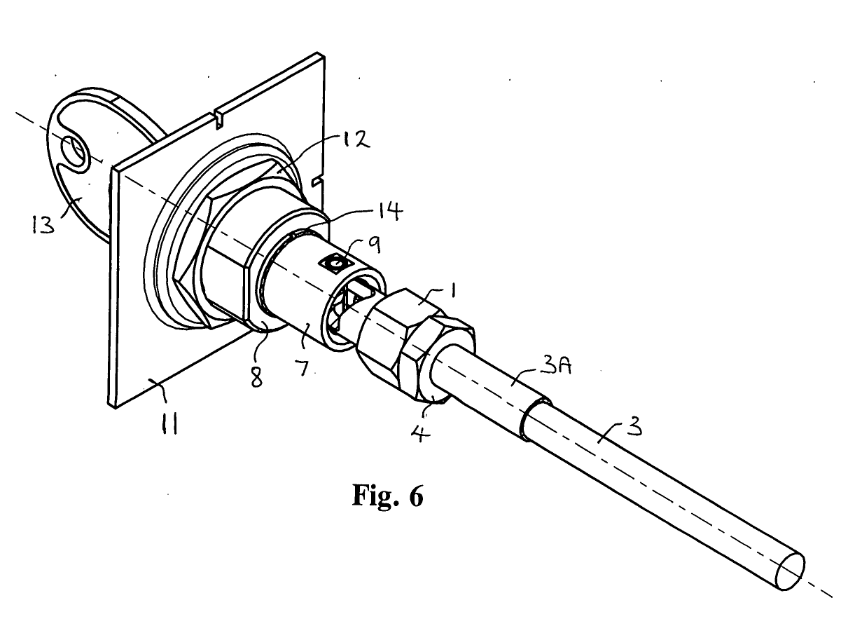

The shaft component 1, which is shown in FIGS. 1 and 2, has one end 2 which is internally threaded so as to be able to be screwed on a threaded portion 3A of a machine shaft 3, shown in FIGS. 3 to 6.

The end 2 of the shaft component 1 is provided with a nut formation to allow the component to be screwed onto the shaft 3.

When the shaft component 1 is located in the desired position on the threaded portion 3A, a lock nut 4 is tightened against the end 2 of the shaft component 2 to hold it in place. The other end portion, indicated at 5, of the shaft component 1 is generally cylindrical and is of a diameter that allows it to fit within a bore 6 at one end of a lock plug or barrel 7, the barrel 7 itself being held within a lock housing 8. Within the bore 6 is located a cross-pin 9 which, when the barrel 7 is offered to the shaft component 1 on the machine shaft 3, is accepted into the open end of a slot 10 in the other end portion 5 of the shaft component 1.

As can be seen, the slot 10 has a first portion 10A which runs substantially parallel an axial to the body of the end portion 5 towards the end 2 of the shaft component 1, the first portion 10A running into a second portion 10B which turns at a helical angle to the general run of the first portion 10A and terminates at a blind end in the shaft component 1.

In fact, as shown, it will be noted that the slot 10 comprises two such slots, each being a mirror-image of one another, on opposite walls of the end portion 5, which is otherwise hollow. Once the cross-pin 9 is in the second portions 10B of the slots 10, relative axial movement between the main body of the lock and the shaft component 1 is prevented.

It will thus be seen that the lock barrel 7 can be easily captured on the shaft component 1 once the cross-pin 9 has entered the second portion 10B of the slot, since the barrel has to be turned through less than a single turn, and preferably only a quarter of a turn, on the shaft component 1.

In so doing, a machine cover plate or lid 11, held by a housing nut 12 on the lock, can be securely located to close the container (not shown) containing the items to be vended, whilst being easily opened and removed by release from the shaft component 1 through a reverse quarter turn. Of course, a key 13 is provided to lock and unlock the lock assembly. A wire circlip 14 or other means may be used to secure the barrel 7 within the lock housing 8.

In summary, therefore, the lid 11 is placed on the machine and the cross-pin 9 in the barrel 7 is aligned with the slots in the shaft component 1, the key 13 is turned and the lid 11 is drawn tightly shut and removal of the key locks the barrel 7 in place. The housing 8 may be provided with splines to permit for easier alignment opening is the reverse of this, with the lock coming away attached to the lid 11.

We claim:

1. A quick-release secure converter to convert a lock for a vending or gaming machine or the like, the machine being of a type which carries a threaded, lock-receiving shaft, onto a threaded end of which the lock is normally screwed, in known manner, in order to secure a closure lid in place over an opening in the machine; the quick-release/secure converter comprising a two-ended, internally-threaded shaft component for threadably engaging, at one end of the component, with the thread on the shaft and there being means to hold the component fast on the shaft once screwed onto it, and the shaft component having, at its other end, means to receive and capture a main body of the lock, so arranged to permit less than a single turn of the lock on the converter to capture or release the main body of the lock, the converter having been previously installed on the machine lock-receiving shaft in use of the lock and converter.

2. A lock converter according to claim 1, wherein the means to receive and capture the lock includes a slot open to said other end of the shaft component and having a first part running towards said one end of the shaft component and the slot at a portion of the converter remote from said other end having a second part turning at an angle to the general run of the first part and terminating at a blind end in the converter, said slot serving to receive a cross-pin of a barrel of the lock and thereby enabling the lock to be captured on the converter to tighten the lid securely once the cross-pin has entered said second part of said slot, whilst permitting less than a single turn of the lock on the converter.

3. A converter according to claim 2, wherein the slot in the shaft component is arranged to allow no more than one quarter of a turn of the lock and/or lock barrel to secure the machine cover in place or to release it.

4. A converter according to claim 2, wherein the barrel is provided with a keyhole to receive a key.

5. A converter according to claim 2, wherein the angle at which the second part turns is such that the second part of the slot is helical.

6. A converter according to claim 2, wherein a lock nut is provided to secure the shaft component on the machine shaft.

7. A converter according to claim 2, wherein a closure lid of the machine is secured to the main body of the lock.

8. A quick release/secure lock for a vending or gaming machine or the like, the machine being of a type which carries a threaded, lock-receiving shaft, onto a threaded end of which the lock is normally screwed, in known manner, in order to secure a closure lid in place over an opening in the machine; the quick-release lock comprising a main body including a barrel within a housing, and there being a two-ended, internally-threaded shaft component for threadably engaging, at one end of the component, with the thread on the shaft and there being means to hold the component fast on the shaft once screwed onto it and the shaft component having, at its other end, means to receive and capture the main body of the lock, so arranged to permit less than a single turn of the main body of the lock on the shaft component to capture or release the main body of the lock, the shaft component having been previously installed on the machine lock-receiving shaft.

9. A lock according to claim 7, wherein the barrel has an open end within which a cross-pin is located and the means on the shaft component to receive and capture the main body of the lock includes a slot open to said other end of the shaft component and having a first part running towards said one end of the shaft component and the slot at a portion of the shaft component remote from said other end having a second part turning at an angle to the general run of the first part and terminating at a blind end in the shaft component, the slot serving to receive and capture the cross-pin of the barrel of the lock and thereby enabling the main body of the lock to be captured on the shaft component once the cross-pin has entered said second part of the slot, whilst permitting less than a single turn of the barrel of the lock on the shaft component.

10. A lock according to claim 9, wherein the slot in the shaft component is arranged to allow no more than one quarter of a turn of the lock and/or lock barrel to secure the machine cover in place or to release it.

11. A lock according to claim 9, wherein the barrel is provided with a keyhole to receive a key.

12. A lock according to claim 9, wherein the angle is such that the second part of the slot is helical.

13. A lock according to claim 9, wherein a lock nut is provided to secure the shaft component on the machine shaft.

14. A lock according to claim 9, wherein a closure lid of the machine is secured to the main body of the lock.
